(19) United States
(12) Patent Application Publication
(10) Pub. No.: US 2021/0004547 A1
(43) Pub. Date: Jan. 7, 2021

(54) DEVICE, SYSTEM AND METHOD FOR SCANNING ANIMAL WITH AN IMPLANTED MICROCHIP

(71) Applicant: BOTLIFE AUTOMATION TECHNOLOGIES INC., MONTREAL (CA)

(72) Inventors: ZAIDI HAMID, Montreal (CA); OUSAMA HRAKI, Montreal (CA); CHRISTOPHE BERRY, Montreal (CA); HUGO HENRY-GARON, Terrebonne (CA); MOURAD DENDANE, Terrebonne (CA); CYRIL CHAIB, Montreal (CA); KATHLEEN ST-PIERRE, Montreal (CA); JEAN-MICHEL LAVOIE, Montreal (CA); ALVARO GEOVANY RAMIREZ URIBE, Montreal (CA)

(21) Appl. No.: 16/968,809

(22) PCT Filed: Feb. 8, 2019
(86) PCT No.: PCT/CA2019/050170

§ 371 Date: Aug. 10, 2020

Related U.S. Application Data
(60) Provisional application No. 62/628,042, filed on Feb. 8, 2018.

(51) Int. Cl. G06K 7/10; G06K 19/07; G06K 19/077; H01Q 1/22; A01K 11/00

(52) U.S. Cl. CPC G06K 7/10386; G06K 7/10297; G06K 7/10316; A01K 11/008; G06K 19/07758; H01Q 1/2208; G06K 19/0724

(57) ABSTRACT

The present invention provides a device and system to scan a microchip implanted in an animal and to retrieve the information stored within the microchip implants. The device is further configured to fetch from one or more databases to identify information associated with 5 the microchip implants. The device to scan the microchip implant is configured to scan at multiple frequencies and to detect the presence of the microchip. Once detected, the information is read from the microchip using the identified frequency of communication.

### CROSS-REFERENCE TO RELATED APPLICATIONS

The present patent application claims the benefits of priority of U.S. Provisional Patent Application No. 62/628,042, entitled “Bluetooth enabled RFID scanner with companion app” and filed at the United States Patent and Trademark Office on Feb. 8, 2018.

### FIELD OF THE INVENTION

The present invention generally relates to systems and methods for scanning and identifying animals. More particularly, the present invention relates to systems and methods for scanning and identifying animal having an implanted microchip and managing the information linked to the microchip.

### BACKGROUND OF THE INVENTION

A lack of regulation and standardization in the animal identification industry have allowed manufacturers much latitude to develop products. Such situation led to the development of several different kinds of microchip implants for animals. Each manufacturer/brand owner uses proprietary microchips and/or communication protocols for RFID microchips. Currently, the majority of the microchips on the market operate at three different frequencies (125, 128, 134 kHz). To read the microchips, each technology requires the use of a scanner specific to the microchip or a compatible aftermarket scanner. Although an ISO standard was created to attempt to standardise the frequency and protocol at which the microchips operate (ISO 11784, 11785), the adoption rate is still low.

The typical process to identify the microchip used by prior art devices is as follow:
1. locate a compatible scanner for the branded microchip implanted in the animal;
2. scan the animal with the compatible scanner;
3. retrieve the implant code that is displayed on the scanner;
4. iterate a list of microchip companies to identify which one the implant code belongs to;
5. call the company to inquire about the animal or access a web site or it up online

There is thus a need for a device and/or a method aiming at reducing the number of steps and time required to identify an animal having microchip implant.

### SUMMARY OF THE INVENTION

The aforesaid and other objectives of the present invention are realized by generally providing a scanner adapted to scan and identify an animal having any microchip implant.

The present invention provides a device and system aiming at simplifying and improving the current way to retrieve the information stored within the microchip implants. The provided system uses a multi-frequency scanner, a database to store the microchip unique ID and any information related to that ID and an external computerized device adapted to communicate data with scanner. In some aspects of the invention, the scanner comprises a touchscreen, a mobile phone chip, a device-to-device communication module and/or a wireless communication module.

The cellular enabled universal smart scanner will allow it to be compatible with existing microchips. This will allow already implanted animals to keep their microchip and still register to the new database. The cellular enabled universal smart scanner will also have the ability to read Near-Field-Communication (NFC) chips.

Additionally, the microchip database would not be limited to one manufacturer. Animals that are currently microchipped would also be able to register to this database.

In another aspect of the invention, a method for scanning and identifying an animal having a microchip implant may comprise implant the microchip in the animal, scan the chip using the multi-frequency scanner and register the animal using scanner.

Afterwards, whenever an animals' microchip is scanned for a microchip with the scanner, the profile automatically opens on the scanner. The database may be stored locally on the scanner allowing the scanner to work without network or Internet connectivity. In the event where the scanned microchip belongs to another manufacturer, the scanner will automatically use multiple frequencies to determine the brand of the microchip. In some instances, if the database of the owner of the microchip may not be accessed, the phone number of the owner of the microchip is displayed on the external computerized device or on the screen of the scanner.

In the event the cellular enabled universal smart scanner does not possess a screen, a Bluetooth® computerized device is required to pair the cellular enabled universal smart scanner to have the same functionality.

In one aspect of the invention, a handled device for scanning a Radio Frequency Identification (RFID) compatible microchip implanted in an animal is provided. The device comprises a power system, RFID module, the RFID module being configured to scan for the presence of the microchip at a plurality of predetermined frequencies, establish a communication link with the microchip at one of the predetermined frequencies compatible with the microchip and, scan and fetch a unique identification code stored in the microchip. The device further comprises a processing unit fed by the power system, the processing unit being configured to control the RFID module, to process the unique identification code fetched by the RFID module and to store the fetched unique identification code.

The device further may further comprise a wireless communication module, the wireless communication module being configured to establish a communication link with an external computerized device, the processing unit being further configured control the wireless communication module and to communicate to the fetched unique identification code to an external computerized device using the wireless communication module. The wireless communication module may be configured to establish a device to device communication link with an external computerized device.

The RFID module may further comprise a RFID antenna configured to emit and receive signals at multiple radio frequencies. The RFID antenna may further be configured to establish a read communication link at the following frequencies: 125 kHz, 128 kHz, 134 kHz and 13.56 MHz.

The processing module may be further configured to dynamically configure the RFID module to communicate with the microchip to be scanned. The processing module may be further configured to request the RFID module to use a frequency associated with the microchip to be scanned. The microchip may be compatible with Near Field Communication (NFC) standards, the antenna being further adapted to communicate with the microchip via NFC communication protocol.

The device may further comprise an activation module being fed by the power system and being configured to command the RFID module, the activation module being configured to activate or deactivate the scanning of the presence of the microchip. The activation module may further comprise a physical switch and a plurality of light sources, the physical switch triggering the activation or deactivation of the scanning and the light sources indicating status of the device. The device may be covered by a housing, the housing comprising a top portion, a light diffusing portion and a bottom portion, the light diffusing portion being adapted to diffuse light emitted by the light sources. The light diffusing portion may be made of translucid material at its periphery.

The device may further comprise a display unit controlled by the processing unit, the display unit being configured to at least display the unique identification code. The display unit may be a touchscreen configured to activate or deactivate the RFID module by touching the display unit.

The device may further comprise a localization module controlled by the processing unit, the localization module being configured to provide the geographical coordinates at the time of the scanning by the RFID module. The localization module may be a GPS unit.

In another aspect of the invention, a computer-implemented method for scanning and identifying an animal having a RFID-compatible microchip implant is provided. The method comprises turning on the scanner, identifying a frequency of operation of the RFID-compatible microchip by scanning at a plurality of predetermined frequencies, scanning and fetching a unique identification code from the RFID-compatible microchip at the identified frequency, communicating the fetched unique identification code to the external computerized device using the device to device communication link and fetching information about the animal and the owner of the animal associated with the fetched unique identification code.

The method may further comprise providing a program in memory of an external computerized device, the program being configured to wirelessly communicate with a scanner and establishing a wireless communication link between the scanner and the external computerized device. The method may further comprise fetching and matching the fetched unique identification code in one or more database to identify one or more owner of the microchip. The method may further comprise, upon matching the owner of the microchip, displaying information of the identified owner of the microchip. The method may further comprise automatically communicating the unique identification code to the owner of the microchip and automatically retrieving from the owner of the microchip information about the animal associated with the microchip. The retrieved information may be at least one of the followings: the address of the owner of the animal, the electronic address of owner of the animal, the name of the animal, characteristics of the animal and health status of the animal.

The method may further comprise prompting the external computerized device if the scanned unique identification code does not match any code from the at one or more databases. The matching of the microchip identification code may further comprise accessing the one or more databases through a remote network.

The method may further comprise generating a report based on the fetched information about the animal. The method may further comprise generating and communicating an alert to the owner of the animal based on fetched information. The alert may comprise at least one of the followings: timestamp of the scanning, geographic coordinates of the animal at the time of the scanning and status of the animal.

In yet another aspect of the invention, a system for scanning and identifying an animal having a RFID-compatible microchip implant is provided. The system comprises a handled scanner device comprising a Radio Frequency Identification (RFID) module, the RFID being configured to scan for the presence of the microchip at a plurality of predetermined frequencies, establish a communication link with the microchip at one of the predetermined frequencies compatible with the microchip and, scan and fetch a unique identification code stored in the microchip. The handled device scanner device may further comprise a processing unit fed by the power system, the processing unit being configured to control the RFID module, to process the unique identification code fetched by the RFID module and to store the fetched unique identification code. The system further comprises a database in communication with the handled scanner, the database being configured to store a unique identification code associated with the microchip implant and information related to the unique identification code.

The system may further comprise an external computerized device, the external computerized device comprising a wireless communication module, the handled scanner device further comprising a wireless communication module, the wireless communication module being configured to establish a communication link with the wireless communication module of the external computerized device, the processing unit being further configured control the wireless communication module of the device and to communicate to the fetched unique identification code to the external computerized device using the wireless communication module. The external computerized device may be configured to execute instructions to receive the scanned information from the handled scanner device including the unique microchip identification code and to match the unique microchip identification code the database.

The system may further comprise at least one remote server accessible through a network, the server being configured to store information in relation with the unique identification code. The external computerized device may be further configured to retrieve information about an owner of the animal associated from the at least one remote server. The external computerized device may be further configured to communicate an electronic alert to the owner of the animal.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 is a perspective view of a device for scanning and identifying an animal having a microchip implant according to an embodiment of the present invention

FIG. 2 is an exploded view of a device for scanning and identifying an animal having a microchip implant according to an embodiment of the present invention.

FIG. 3 is an illustration of a system for scanning and identifying an animal having a microchip implant according to an embodiment of the present invention.

### DETAILED DESCRIPTION OF THE PREFERRED EMBODIMENT

A novel System and Method for Scanning Animal with an Implanted Microchip will be described hereinafter. Although the invention is described in terms of specific illustrative embodiment(s), it is to be understood that the embodiment(s) described herein are by way of example only and that the scope of the invention is not intended to be limited thereby.

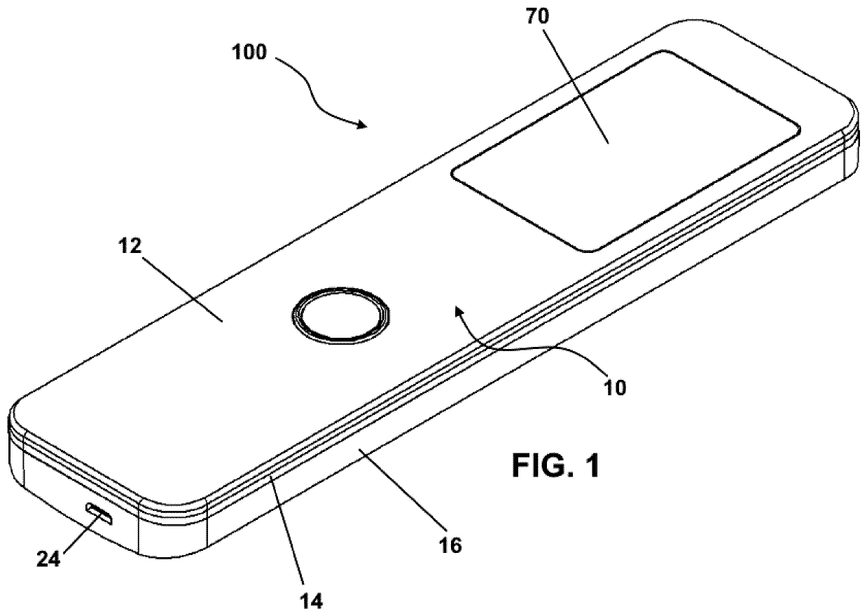

Referring to FIG. 1, an embodiment of a mobile network enabled universal smart scanner 100 is shown. The scanner 100 typically comprises a housing 10. The housing is typically designed to be handheld and rugged.

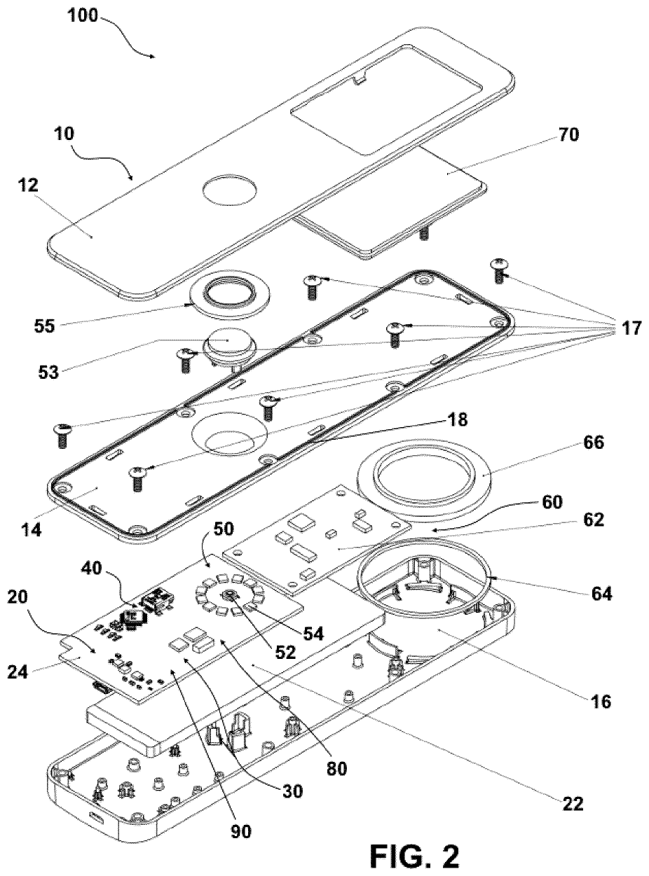

Referring now to FIGS. 1 and 2, in some embodiments, the housing 10 may be made of a plurality of portions, such as a top cover 12, a light diffuser 14 and a bottom cover 16. The portions are typically attached to another using any fastening method such as fasteners, such as bolts 17, interlocking edges 18, etc., or may be glued together. The light diffuser 14 is typically made of translucid material at its periphery to allow light to diffuse from the housing 10.

In some embodiments, internal components of the scanner 100 may be fastened in between the bottom cover 16 and the light diffuser 14.

The scanner 100 may further comprise a power system 20, a device to device communication system 30, such as a Bluetooth® module, a processing module 40, an activation module 50, a Radio Frequency Identification (RFID) module 60, an optional display device 70, an optional wireless communication module 80, such as Wi-Fi or cellular communication module, and an optional localization system 90, such as a GPS module.

The power system 20 typically comprises a portable power source 22, such as a rechargeable battery, and a charging system 24. The battery charger 24 is typically configured to be activated only when a cable to an external power source is connected to the charging system 20. Typically, any type of USB may be used to connect to the external power source. Once the charger 24 detects an external power source, the charger 24 activates the charging process of the battery 22. In some embodiments, the activated charger 24 may also supply current to other modules of the scanner 100 requiring electrical power. The process of activating the charging and/or powering the scanner 100 is preferably executed without interrupting use of the scanning device 100.

The device to device communication system 30 is configured to establish a communication link between the scanner 100 and an external computerized device, such as a smart phone, a watch, a computer, a tablet or any other type of computerized device configured to establish a device to device communication link. Broadly, the device to device communication system allows the scanner 100 to communicate the retrieved information from the microchip or from an internal database to the external computerized device.

In a typical embodiment, the external device executes a program adapted to establish the link between the scanner 100 and the external device, such as by establishing a Bluetooth® communication link. Once the link is established, the link remains active until either the external computerized device or the scanner 100 is out of range, is turned off or is manually unlinked by a user.

The processing module 40 typically comprises a central processing unit (CPU) and a memory unit. The processing module 40 is configured to control peripheral devices or modules of the scanner 10, such as the device to device communication system 30 and the RFID module 60. The processing module 40 is further configured to process information received from the RFID module 60 and to transfer such information to the external device using any of the device to device communication module 30 and/or to wireless communication module 80. The external computerized device is configured to process the received information from the scanner 100 and/or to send information to the scanner 100 by communicating with the device communication module 30 and/or to wireless communication module 80.

The activation module 50 typically comprises a physical switch 52 and multiple light sources 54, such as light emitting diodes (LED). The light sources 54 generally serve as a visual reference to the user and/or indication of the current status of the scanner 100. The physical switch 52 is generally responsible for activating the scanning feature of the scanner 100. The physical switch 52 may be actioned via any type of activation mechanism, such as by pressing a button 53. When the activation mechanism is activated, the physical switch 52 sends a signal to the processing module 40 to activate communication feature of the scanning device 100. In some embodiments, the button 53 may be attached to the housing 10 using any attachment mean, such as with a ring 55 adapted to align the button 53 in an aperture of the top cover 12 and to retain the button 53 between the top cover 12 and the light diffuser 14.

The RFID module 60 generally handles the transmitting and receiving capabilities of the scanner 100 with a microchip implant. In a typical embodiment, the RFID module 60 comprises a RFID antenna 64 connected to a RFID controller 62. The RFID antenna 64 is configured to emit a signal at multiple radio frequencies. The RFID controller 62 is configured to receive the frequency at which operates from the processing module 40 and to emit a signal at the received frequency through the RFID antenna 64. The RFID controller 62 may also be configured to act as a receiver of information received from the microchip implant. The antenna 64 may be protected and held in place by an antenna cover 66.

In a preferred embodiment, the antenna 64 is designed to work with multiple frequencies. The multi-frequency feature aims at the scanner 100 to be able to communicate with most of popular microchips currently in use and also aims at reducing the need to have specialized equipment made specifically for one type of microchip. In some embodiments, the antenna 64 is configured and/or adapted to be compatible with ISO standards currently set in place for the microchip implants. In yet other embodiments, the antenna is also configured to be compatible with Near Field Communication (NFC) standards for NFC enabled microchips. The RFID controller 62 may comprise transceiver module circuitry configured to operate at multiple frequencies. This integrated circuit typically covers at least three frequencies and both the Amplitude Modulation (AM) scheme and the Frequency Modulation scheme (FM). To make the scanner to communicate with a variety of tags, the processing module 40 is configured to select or set the adequate configuration of the transponder in real-time or on the fly.

The scanner 100 may further comprise a display unit 70. The display unit 70 may be embodied as a standard display or as a touchscreen. The display unit 70 is typically installed between the top cover 12 and the light diffuser 14. The display unit 70 is controlled by the processing module 40 and is adapted for the scanner 100 to display information transmitted to external computerized device. In embodiments having a touchscreen unit, the touchscreen may also act as an interface for the user to activate the scanner or to configure different parameters, such as changing the frequency of operation or selecting a predetermined type of microchip implant to communicate with.

Understandably, in embodiments having a display unit 70, the scanner 100 may omit the device-to-device communication module 30 the information may be displayed on the display unit 70 instead of on a linked external computerized device.

The scanner 100 may comprise a localization module 90 adapted to identify the location of the scanner 100. The localization module 90 is configured to store the coordinates at the time of a scanning of an animal. In such embodiments, the localization module 90 is configured to communicate the coordinates to the processing module 40. The processing module 40 then either transmits the coordinates to the external computerized device or executes a program to send the coordinates of the animal to an owner associated with the animal. The coordinates may be communicated by any electronic means of communication, such as email, notification in a program executed by the external computerized device, text message, etc.

In other embodiments, the scanner 100 may further comprise a smart card reader and controller, a data card reader and controller and/or a PCMCIA card reader and controller. Such optional readers and controllers may be used to store information directly on the scanner 100, such as retrieved information from the microchip, from the one or more databases and/or communicated from the external computerized device.

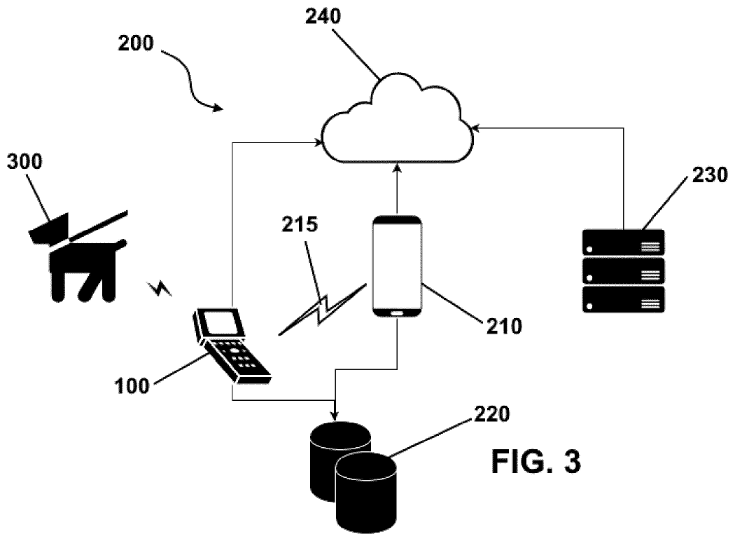

Referring now to FIG. 3, a system for scanning and identifying an animal having a microchip implant 200 is shown. The system comprises a smart scanner 100 adapted to scan and fetch a unique identification of a microchip implant of an animal 300 over multiple frequencies as described above. The scanner 100 is configured to access one or more databases 220 to identify the owner of the scanned microchip implant.

In some embodiments, the system 200 may further comprise an external computerized device 210 configured to establish a device-to-device communication link 215 with the scanner 100. Upon scanning the unique identification code of the microchip implant of the animal 300, the scanner 100 may be configured to communicate the said unique identification code to the external computerized device 210 through the device-to-device communication link 215. In such embodiments, the external computerized device 210 is configured to access and fetch the one or more databases comprising owner of the microchip implant. In yet other embodiments, the system may further comprise a network 240, such as the Internet. The one or more databases 220 may be connected to the network or accessible through the network. In some embodiments, the scanner 100 is configured to access the database 220 through the network.

In some embodiments, the system 200 further comprises at least one accessible remote server 230 hosting data associated with the microchip implant. Typically, such servers 230 are run and/or hosted by the owner of the microchip implant.

The external computerized device 210 typically comprises a CPU, a memory unit and a device-to-device communication module. The CPU is configured to execute instructions to receive the scanned information from the scanner 100 including a unique microchip identification code, to match the unique microchip ID with microchip ID present in known databases, to retrieve information about the organization or company managing the microchip ID and to notify the user of the said organization or company.

A method for scanning and identifying an animal is also provided. The method typically comprises downloading and installing a program in the memory of the external computerized device, the program being configured to wirelessly communicate with the scanner 100, turning on the scanner 100, establishing a device to device communication link between the scanner 100 and the external computerized device, such as establishing a Bluetooth® communication link, using the scanner 100 to scan a unique identification code from a microchip implanted in an animal and communicating the unique identification code to the external computerized device using the device to device communication link.

The method may further comprise the program of the computerized device requesting the user to fetch and match the scanned unique identification code in one or more databases to find organization or company owning the microchip. Upon matching owner of the microchip, displaying information of the matching organization or company. The method may further comprise the computer program allowing the user to automatically communicate with matching organization or company. The method may further comprise retrieving the information associated with the microchip from the organization or company, such as the name of the owner, the address of the owner, the electronic address of the email, such as an email, the name of the animal, characteristics of the animal, health status of the animal, etc.

The method may further comprise prompting a user to register the scanned unique identification code if not match is detected. The method than further comprises activating a method to register the microchip identification number.

The method may further comprise pressing on the activation device to start the scanning process of the scanner 100.

In some embodiments, the step of matching the microchip identification code may further comprise the external computerized device or the scanner 100 accessing a remote network, such as the internet, to fetch the microchip ID code.

The method may further comprise the external computerized device generating a report about the status of the animal based on the microchip identification code.

The method may further comprise the external computerized device or the scanner 100 generating and communicating an alert to the owner of the animal upon retrieving information about the animal from the company or the organization. The alert may comprise the timestamp of the scanning or matching process, the geographic coordinates of the animal at the time of scanning or any other information that could be input into the scanner 100 or in the external computerized device at the time of scanning.

While illustrative and presently preferred embodiment(s) of the invention have been described in detail hereinabove, it is to be understood that the inventive concepts may be otherwise variously embodied and employed and that the appended claims are intended to be construed to include such variations except insofar as limited by the prior art.

What is claimed is:

1) A handled device for scanning a Radio Frequency Identification (RFID) compatible microchip implanted in an animal, the device comprising:
a power system;
a RFID module, the RFID module being configured to:
scan for the presence of the microchip at a plurality of predetermined frequencies;
establish a communication link with the microchip at one of the predetermined frequencies compatible with the microchip;
scan and fetch a unique identification code stored in the microchip;
a processing unit fed by the power system, the processing unit being configured to:
control the RFID module;
process the unique identification code fetched by the RFID module;
store the fetched unique identification code.

2) The device of claim 1, the device further comprising a wireless communication module, the wireless communication module being configured to establish a communication link with an external computerized device, the processing unit being further configured control the wireless communication module and to communicate to the fetched unique identification code to an external computerized device using the wireless communication module.

3) The device of claim 2, the wireless communication module being configured to establish a device to device communication link with an external computerized device.

4) The device of claim 1, the RFID module further comprising a RFID antenna configured to emit and receive signals at multiple radio frequencies.

5) The device of claim 2, the RFID antenna being of establish a read communication link at the following frequencies: 125 kHz, 128 kHz, 134 kHz and 13.56 MHz.

6) The device of claim 1, the processing module being further configured to dynamically configure the RFID module to communicate with the microchip to be scanned.

7) The device of claim 6, the processing module being further configured to request the RFID module to use a frequency associated with the microchip to be scanned.

8) The device of claim 7, the microchip being compatible with Near Field Communication (NFC) standards, the antenna being further adapted to communicate with the microchip via NFC communication protocol.

9) The device of claim 1, the device further comprising an activation module being fed by the power system and being configured to command the RFID module, the activation module being configured to activate or deactivate the scanning of the presence of the microchip.

10) The device of claim 9, the activation module further comprising a physical switch and a plurality of light sources, the physical switch triggering the activation or deactivation of the scanning and the light sources indicating status of the device.

11) The device of claim 10, the device being covered by a housing, the housing comprising a top portion, a light diffusing portion and a bottom portion, the light diffusing portion being adapted to diffuse light emitted by the light sources.

12) The device of claim 11, the light diffusing portion being made of translucid material at its periphery.

13) The device of claim 1, the device further comprising a display unit controlled by the processing unit, the display unit being configured to at least display the unique identification code.

14) The device of claim 13, the display unit being a touchscreen configured to activate or deactivate the RFID module by touching the display unit.

15) The device of claim 1, the device further comprising a localization module controlled by the processing unit, the localization module being configured to provide the geographical coordinates at the time of the scanning by the RFID module.

16) The device of claim 15, the localization module being a GPS unit.

17) A computer-implemented method for scanning and identifying an animal having a Radio Frequency Identification (RFID) compatible microchip implant, the method comprising:
turning on a scanner device;
identifying a frequency of operation of the RFID-compatible microchip by scanning a plurality of predetermined frequencies;
scanning and fetching a unique identification code from the RFID-compatible microchip at the identified frequency;
fetching information about the animal and the owner of the animal associated with the fetched unique identification code in one or more databases.

18) The method of claim 17, the method further comprising:
providing a program in memory of an external computerized device, the program being configured to wirelessly communicate with a scanner;
establishing a wireless communication link between the scanner and the external computerized device.

19) The method of claim 18, the method further comprising communicating the fetched unique identification code to the external computerized device using a device to device communication link;

20) The method of claim 19, the method further comprising prompting the external computerized device if the scanned unique identification code does not match any code from the at one or more databases.

21) The method of claim 17, the method further fetching and matching the fetched unique identification code in the one or more database to identify one or more owner of the microchip.

22) The method of claim 21, the method further comprising, upon matching the owner of the microchip, displaying information of the identified owner of the microchip.

23) The method of claim 22, the method further comprising automatically communicating the unique identification code to the owner of the microchip and automatically retrieving from the owner of the microchip information about the animal associated with the microchip.

24) The method of claim 23, the retrieved information being at least one of the followings: the address of the owner of the animal, the electronic address of owner of the animal, the name of the animal, characteristics of the animal and health status of the animal.

25) The method of claim 17, the matching of the microchip identification code further comprising the accessing the one or more databases through a remote network.

26) The method of claim 17, the method further comprising generating a report based on the fetched information about the animal.

27) The method of claim 17, the method further comprising generating and communicating an alert to the owner of the animal based on fetched information.

28) The method of claim 27, the alert comprising at least one of the followings: timestamp of the scanning, geographic coordinates of the animal at the time of the scanning and status of the animal.

29) A system for scanning and identifying an animal having a Radio Frequency Identification (RFID) compatible microchip implant, the system comprising:
a handled scanner device comprising:
a RFID module, the RFID module being configured to:
scan for the presence of the microchip at a plurality of predetermined frequencies;
establish a communication link with the microchip at one of the predetermined frequencies compatible with the microchip;
scan and fetch a unique identification code stored in the microchip;
a processing unit fed by the power system, the processing unit being configured to:
control the RFID module;
process the unique identification code fetched by the RFID module;
store the fetched unique identification code;
a database in communication with the handled scanner device, the database being configured to store a unique identification code associated with the microchip implant and information related to the unique identification code.

30) The system of claim 29, the system further comprising an external computerized device, the external computerized device comprising a wireless communication module, the handled scanner device further comprising a wireless communication module, the wireless communication module being configured to establish a communication link with the wireless communication module of the external computerized device, the processing unit being further configured control the wireless communication module of the device and to communicate to the fetched unique identification code to the external computerized device using the wireless communication module.

31) The system of claim 30, the external computerized device being configured:
to execute instructions to receive the scanned information from the handled scanner device including the unique microchip identification code;
to match the unique microchip identification code the database.

32) The system of claim 31, the system further comprising at least one remote server accessible through a network, the server being configured to store information in relation with the unique identification code.

33) The system of claim 32, the external computerized device being further configured to retrieve information about an owner of the animal associated from the at least one remote server.

34) The system of claim 33, the external computerized device being further configured to communicate an electronic alert to the owner of the animal.
